(19) United States
(12) Patent Application Publication
(10) Pub. No.: US 2026/0197106 A1
(43) Pub. Date: Jul. 9, 2026

(54) RAY TRACING-BASED METHOD FOR INDOOR MULTI-BASE STATION LOCATION OPTIMIZATION IN MILLIMETER WAVE FREQUENCY BAND

(71) Applicant: NANJING JIEXI TECHNOLOGY CO., LTD., Jiangsu (CN)

(72) Inventors: Chengxiang WANG, Jiangsu (CN); Dantong CHEN, Jiangsu (CN); Songjiang YANG, Jiangsu (CN); Yinghua WANG, Jiangsu (CN); Baohua CAO, Jiangsu (CN); Xiaocong WANG, Jiangsu (CN)

(73) Assignee: NANJING JIEXI TECHNOLOGY CO., LTD., Jiangsu (CN)

(21) Appl. No.: 19/550,120

(22) Filed: Feb. 25, 2026

Related U.S. Application Data
(63) Continuation of application No. PCT/CN2023/126691, filed on Oct. 26, 2023.

(30) Foreign Application Priority Data
Aug. 28, 2023 (CN) 202311085001.6

(51) Int. Cl. H04B 17/391; H04W 16/18; H04W 24/02; H04W 72/0453

(52) U.S. Cl. CPC H04B 17/3912; H04W 16/18; H04W 24/02; H04W 72/0453

(57) ABSTRACT

The present invention provides a ray tracing-based method for indoor multi-base station location optimization in a millimeter wave frequency band, comprising: constructing an indoor millimeter wave network model; determining an indoor millimeter wave network model optimization constraint condition; constructing a cost function of multi-base station location deployment on the basis of the constraint condition; determining the initial location of each base station in the indoor millimeter wave network model; and by taking the initial location of each base station as a starting point, determining an optimal location of each base station by means of axial search together with pattern search. According to the present invention, a good balance can be achieved between the accuracy of optimization results and the complexity of optimization algorithms for the multi-base station deployment optimization problem, so that the optimized base station locations can provide high-quality signal coverage for an indoor millimeter wave network.

### CROSS-REFERENCE TO RELATED APPLICATION

This application is a continuation of international application of PCT application serial no. PCT/CN2023/126691 filed on Oct. 26, 2023, which claims the priority benefit of China application no. 202311085001.6 filed on Aug. 28, 2023. The entirety of each of the above-mentioned patent applications is hereby incorporated by reference herein and made a part of this specification.

### TECHNICAL FIELD

The present invention relates to the technical field of wireless communication, and in particular to a ray tracing-based method for indoor multi-base station location optimization in a millimeter wave frequency band.

### BACKGROUND

With the rapid surge in the number of smart devices and intelligent applications, 5G mobile communication systems will struggle to accommodate the massive number of mobile devices, making 6G technology a hotspot for further research and development. In addition, influenced by the usage habits of mobile users, the majority of current mobile communication services are concentrated indoors. With the advantages and disadvantages, such as high rates, large bandwidth, significant propagation loss, and weak penetration capability, millimeter-wave technology is one of the core technologies of 6G. Because of its weak penetration capability, millimeter-wave technology is mostly applied in indoor and other short-range communication scenarios. However, millimeter-wave propagation is more sensitive to obstacles along its path, meaning that different base station locations will significantly affect network signal quality and coverage. Therefore, research on indoor multi-base station location optimization in a millimeter wave band places higher demands on precision.

At present, research methods for indoor base station deployment optimization are mainly divided into two categories. One method involves adjusting base station locations, antenna angles, and other parameters, and then analyzing signal variations to find a relatively optimal base station deployment scheme. This method has low complexity, but it only provides a feasible base deployment scheme, rather than a globally optimal solution. The other method involves constructing a mathematical model, reformulating the base station deployment optimization problem into a mathematical optimization problem, and using different optimization methods to seek the optimal solution. Compared with the first method, the second method can provide a more accurate and reliable base station deployment scheme. On the basis of the second method, some scholars have used ray-tracing methods to obtain wireless channel parameters required for optimization, aiming to further improve the precision of base station deployment optimization. However, due to the high complexity of ray tracing, optimization algorithms often use simple line search algorithms such as the steepest descent method, which may result in local optimal traps, meaning that the identified optimal solution may be a local optimum. Other scholars have applied high-complexity machine learning algorithms, such as genetic algorithms, to solve for the optimal base station locations. This can avoid local optima and find the global optimum solution. However, due to the high complexity of these optimization algorithms, the wireless channel parameters are often derived from empirical models. In summary, existing research methods struggle to achieve a good balance between the complexity of optimization algorithms and the accuracy of optimization results.

### SUMMARY

In view of the deficiencies in the prior art, the present invention provides a ray tracing-based method for indoor multi-base station location optimization in a millimeter wave frequency band.

In a first aspect, the present invention provides a ray tracing-based method for indoor multi-base station location optimization in a millimeter wave frequency band, including:
constructing an indoor millimeter wave network model;
determining an indoor millimeter wave network model optimization constraint condition;
constructing a cost function of multi-base station location deployment on the basis of the constraint condition;
determining an initial location of each base station in the indoor millimeter wave network model; and
by taking the initial location of each base station as a starting point, determining an optimal location of each base station by means of axial search together with pattern search.

Further, the constructing an indoor millimeter wave network model includes:
constructing a global coordinate system by taking an intersection of length and width of an indoor space as an origin, defining a length direction as an X-axis direction, a width direction as a Y-axis direction, and a direction perpendicular to the X-axis direction and the Y-axis direction as a Z-axis direction, thereby obtaining an indoor hyper-rectangle Q, and Q={(x, y, h_{T})∈R³|0≤x≤a,0≤y≤b}, where a denotes a length of the indoor space, b denotes a width of the indoor space, x denotes a length value of the hyper-rectangle Q, y denotes a width value of the hyper-rectangle Q, h_{T} denotes a height value of an indoor base station, and R³ denotes a three-dimensional real space.

Further, the determining an indoor millimeter wave network model optimization constraint condition includes:

calculating a signal power Pᵢⱼ received by a receiving point i from a base station j according to the following formula:

$${P}_{ij} = {P}_{T} - {P}_{L , ij} ;$$

where i=1, 2, 3, . . . , m; m denotes a total number of receiving points in the indoor space; j=1, 2, 3, . . . , n; n denotes a total number of base stations in the indoor space; P_{T} denotes a transmit power of the base station; and P_{L,ij} denotes a path loss between the receiving point i and the base station j;
a thermal noise Pₙₒᵢₛₑ in the indoor millimeter wave network model is calculated according to the following formula:

$${P}_{noise} = kVB ;$$

where k denotes a Boltzmann constant; V denotes an indoor Kelvin temperature; and B denotes a signal bandwidth;
a signal to interference plus noise ratio γᵢ at the receiving point i is calculated according to the following formula:

$${γ}_{i} = \frac{{P}_{i}}{{{\sum }^{m}}_{j = 1 , j \neq q} {P}_{ij} + {P}_{noise}} ;$$

where Pᵢ denotes a received signal power at the receiving point i; when the receiving point i is connected to a base station q, a signal power P_{iq} received by the receiving point i from the base station q is equal to Pᵢ, and an interference power is

$${{\sum }^{m}}_{j = 1 , j \neq q} {P}_{ij} ;$$

A path loss P_{L,i} at the receiving point i is calculated according to the following formula:

$${P}_{L , i} = {min}_{j = 1 , 2 , … n} \{ {P}_{L , ij} \} ;$$

Constructing the constraint condition as:

$$\{ \begin{matrix}{P}_{L , i} < {P}_{L , th} \\ {γ}_{i} > {γ}_{t h}\end{matrix} ;$$

where φ_{L,th} denotes a predetermined path loss threshold, and γₜₕ denotes a predetermined signal to interference plus noise ratio threshold.

Further, the constructing a cost function of multi-base station location deployment on the basis of the constraint condition includes:
constructing a cost function expression F:

$$F = {φ}_{1} {f}_{1} + {φ}_{2} {f}_{2} + {φ}_{3} {f}_{3} ;$$

where f₁ is a first objective function; f₂ is a second objective function; f₃ is a third objective function; and φ₁+φ₂+φ₃=1; where φ₁ is an optimization priority of the first objective function; φ₂ is an optimization priority of the second objective function; and φ₃ is an optimization priority of the third objective function:

$$\{ \begin{matrix}{f}_{1} = \frac{1}{m} {\sum }_{i = 1}^{m} {ω}_{i} [ {P}_{L , i} + {μ}_{i} max \{ 0 , {P}_{L , i} - {P}_{L , th} \} ] \\ {f}_{2} = \frac{1}{n} {max}_{i = 1 , … , m} \{ {ω}_{i} [ {P}_{L , i} + {μ}_{i} max \{ 0 , {P}_{L , i} - {P}_{L , th} \} ] \} \\ {f}_{3} = \frac{1}{n} {max}_{i = 1 , … , m} \{ {μ}_{i} max \{ 0 , {γ}_{t h} - {γ}_{i} \} \}\end{matrix} ;$$

where ωᵢ denotes a weight of the receiving point i; a magnitude of ωᵢ characterizes a level of demand for network signal quality at the receiving point i; i=1, 2, 3, . . . , m, where m denotes a total number of receiving points in the indoor space; φ_{L,i} denotes a path loss at the receiving point i; P_{L,th} denotes a predetermined path loss threshold; γₜₕ denotes a predetermined signal to interference plus noise ratio threshold; μᵢ denotes a penalty factor at the receiving point i; a magnitude of μᵢ characterizes the severity of consequences caused by P_{L,i} and/or γᵢ failing to meet the thresholds; n denotes a total number of base stations in the indoor space; and γ, denotes a signal to interference plus noise ratio at the receiving point i.

Further, the determining an initial location of each base station in the indoor millimeter wave network model includes:
step 401: determining a weight sum of each hyper-rectangle in a current indoor space, where the weight sum of each hyper-rectangle is a sum of weights of all receiving points within the corresponding hyper-rectangle;
step 402: iterating through weight sums of all hyper-rectangles, and obtaining a hyper-rectangle Qⱼ with a maximum sum of weights;
step 403: calculating centroid coordinates (x_{Q}_{ⱼ}, y_{Q}_{ⱼ}, h_{T}) of the hyper-rectangle Qⱼ according to the following formula:

$$\{ \begin{matrix}{x}_{{Q}_{j}} = \frac{\sum ( {ω}_{i 1} {x}_{i 1} )}{\sum {ω}_{i 1}} \\ {y}_{{Q}_{j}} = \frac{\sum ( {ω}_{i 1} {y}_{i 1} )}{\sum {ω}_{i 1}}\end{matrix} ;$$

where h_{T} denotes a height value of the indoor base station; ωᵢ₁ denotes a weight of a receiving point i1 within the hyper-rectangle Qⱼ; xᵢ₁ denotes an x-coordinate of the receiving point i1 within the hyper-rectangle Qⱼ; and yᵢ₁ denotes a y-coordinate of the receiving point i1 within the hyper-rectangle Qⱼ;
step 404: at a centroid of the hyper-rectangle Qⱼ, dividing the hyper-rectangle Qⱼ into two new hyper-rectangles along a width direction of hyper-rectangle Qⱼ;
step 405: Repeating the steps 401-404 until n centroid coordinates are obtained, and taking the n centroid coordinates as initial locations of n base stations, respectively; where n denotes a total number of base stations in the indoor space.

Further, the by taking the initial location of each base station as a starting point, determining an optimal location of each base station by means of axial search together with pattern search includes:
step 501: constructing a set of x-coordinates and y-coordinates A^{λ} of optimized base station locations:

$${A}^{λ} = {( {x}_{1}^{λ} , {y}_{1}^{λ} , {x}_{2}^{λ} , {y}_{2}^{λ} , … , {x}_{n}^{λ} , {y}_{n}^{λ} )}^{T} ;$$

where λ is a number of optimizing the base station locations;

$${x}_{n}^{λ}$$

denotes an x-coordinate of a location after λ optimizations of a base station n;

$${y}_{n}^{λ}$$

denotes a y-coordinate of the location after λ optimizations of the base station n; and n denotes a total number of base stations in the indoor space;
step 502: constructing a set of starting locations B¹ of base stations for axial search:

$${B}^{1} = {( {x}_{1}^{1} , {y}_{1}^{1} , {x}_{2}^{1} , {y}_{2}^{1} , … , {x}_{n}^{1} , {y}_{n}^{1} )}^{T} ;$$

step 503: moving B¹ along 2n-dimensional directions of B¹ respectively by a target step size, and obtaining a set of x-coordinates and y-coordinates B²ⁿ⁺¹ of a base station location corresponding to a minimum cost function value during the movement process;
step 504: determining whether F(B²ⁿ⁺¹)<F(A^{l}) is satisfied; where F(B²ⁿ⁺¹) denotes a cost function value when the set of x-coordinates and y-coordinates of the base station locations is B²ⁿ⁺¹; and F(A^{l}) is a cost function value when the set of x-coordinates and y-coordinates of the base station locations is A^{l};
step 505: if satisfied, setting A^{l+1}=B²ⁿ⁺¹, and a descent direction vector of the cost function D=A^{l+1}−A^{l}; updating B¹ in a next optimization to A^{l+1}+αD; where l+1≤λ; and α denotes an acceleration factor for accelerating convergence of the axial search and the pattern search;
step 506: if not satisfied, setting δ^{l+1}=βδ^{l}, A^{l+1}=A^{l}, and updating B¹ in a next optimization to A^{l}; where δ^{l} denotes a step size of an l^{th} location optimization of base station; and β denotes a decay factor;
step 507: when performing an l+1 location optimization of base station, determining whether δ^{l+1} is greater than a predetermined allowable error E;
step 508: if so, repeating the steps 501-507; and
step 509: if not, taking A^{l+1} as a final set of x-coordinates and y-coordinates of the base station locations, and ending the location optimization of base station.

In a second aspect, the present invention provides a computer device, including a processor and a memory, where when the processor executes computer programs stored in the memory, the steps of the ray tracing-based method for indoor multi-base station location optimization in a millimeter wave frequency band described in the first aspect are implemented.

In a third aspect, the present invention provides a computer-readable storage medium for storing a computer program, where when the computer program is executed by the processor, the steps of the ray tracing-based method for indoor multi-base station location optimization in a millimeter wave frequency band described in the first aspect are implemented.

The present invention provides a ray tracing-based method for indoor multi-base station location optimization in a millimeter wave frequency band, comprising: constructing an indoor millimeter wave network model; determining an indoor millimeter wave network model optimization constraint condition; constructing a cost function of multi-base station location deployment on the basis of the constraint condition; determining an initial location of each base station in the indoor millimeter wave network model; and by taking the initial location of each base station as a starting point, determining an optimal location of each base station by means of axial search together with pattern search.

The initial solution computation and optimization method used in the present invention can accelerate the optimization algorithm and reduce the solution time for base station deployment optimization. Compared with the traditional pattern search algorithms, this algorithm maintains low complexity and the advantages of a global optimization algorithm, and it can solve an indoor multi-base station optimization problem under the constraint condition that base station locations are necessarily within a feasible interval, and by taking the path loss and signal to interference plus noise ratio as optimization parameters, high quality and full coverage of indoor millimeter-wave network are achieved. The present invention can achieve a good balance between the accuracy of optimization results and the complexity of optimization algorithms for the multi-base station deployment optimization problem, so that the optimized base station locations can provide high-quality signal coverage for an indoor millimeter wave network.

### BRIEF DESCRIPTION OF THE DRAWINGS

In order to more clearly illustrate the technical solution of the present invention, the accompanying drawings required to be used in the description of some embodiments are simply introduced below, and obviously, the accompanying drawings described below are only some embodiments of the present invention, such that for those of ordinary skill in the art, other drawings may further be derived from these drawings without making inventive efforts.

FIG. 1 is a flowchart of a ray tracing-based method for indoor multi-base station location optimization in a millimeter wave frequency band according to an embodiment of the present invention.

FIG. 2 is an application scenario diagram according to an embodiment of the present invention.

FIG. 3 is a schematic diagram of receiving point weight partitioning according to an embodiment of the present invention.

FIG. 4 is a schematic diagram of determined initial base station locations according to an embodiment of the present invention.

FIG. 5 is a cost function convergence curve according to an embodiment of the present invention.

FIG. 6 is a received power distribution obtained by random base station location according to an embodiment of the present invention.

FIG. 7 is a received power distribution diagram obtained using a calculated initial solution as an initial base station location before optimization according to an embodiment of the present invention.

FIG. 8 is a received power distribution diagram after optimization according to an embodiment of the present invention.

FIG. 9 is an SINR diagram obtained by random base station location according to an embodiment of the present invention.

FIG. 10 is an SINR diagram obtained using a calculated initial solution as an initial base station location before optimization according to an embodiment of the present invention.

FIG. 11 is an SINR diagram after optimization according to an embodiment of the present invention.

### DETAILED DESCRIPTIONS OF THE EMBODIMENTS

The technical solutions of embodiments of the present invention will be described below clearly and comprehensively in conjunction with accompanying drawings of the embodiments of the present invention. Apparently, the embodiments described are merely some embodiments rather than all embodiments of the present invention. On the basis of the embodiments in the present invention, all other embodiments acquired by those of ordinary skill in the art without making creative efforts fall within the scope of protection of the present invention.

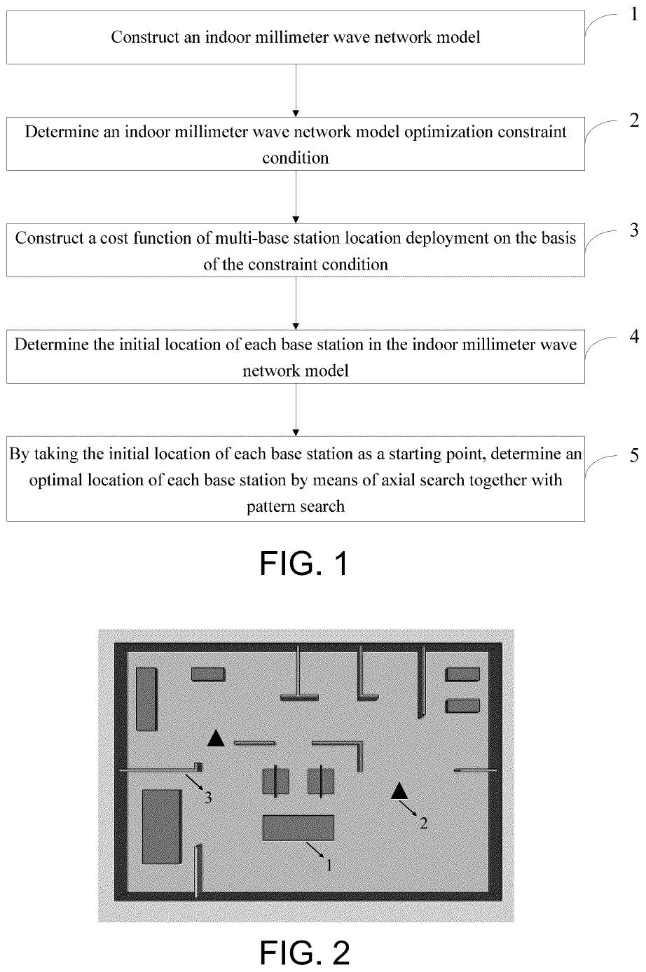

In one embodiment, as shown in FIG. 1, an embodiment of the present invention provides a ray tracing-based method for indoor multi-base station location optimization in a millimeter wave frequency band, including:
Step 1. constructing an indoor millimeter wave network model.

As shown in FIG. 2, an indoor space with a length a of 30 m, a width b of 20 m, and a height of 3 m is illustrated. A plurality of cubes therein represent tables 1, triangles represent base stations 2, and partitions 3 divide the space into a plurality of regions. The indoor millimeter wave network model includes a total of m receiving points and n base stations. A global coordinate system is constructed with a lower-left vertex of an optimization scenario as an origin, and directions parallel to length, width, and height of the optimization scenario as X-axis, Y-axis, and Z-axis, respectively. Coordinates of the receiving points are expressed as (xᵢ, yᵢ, zᵢ), where i=1, 2, 3, . . . , m; and coordinates of the base stations are expressed as (xⱼ, yⱼ, zⱼ), where j=1, 2, 3, . . . , n.

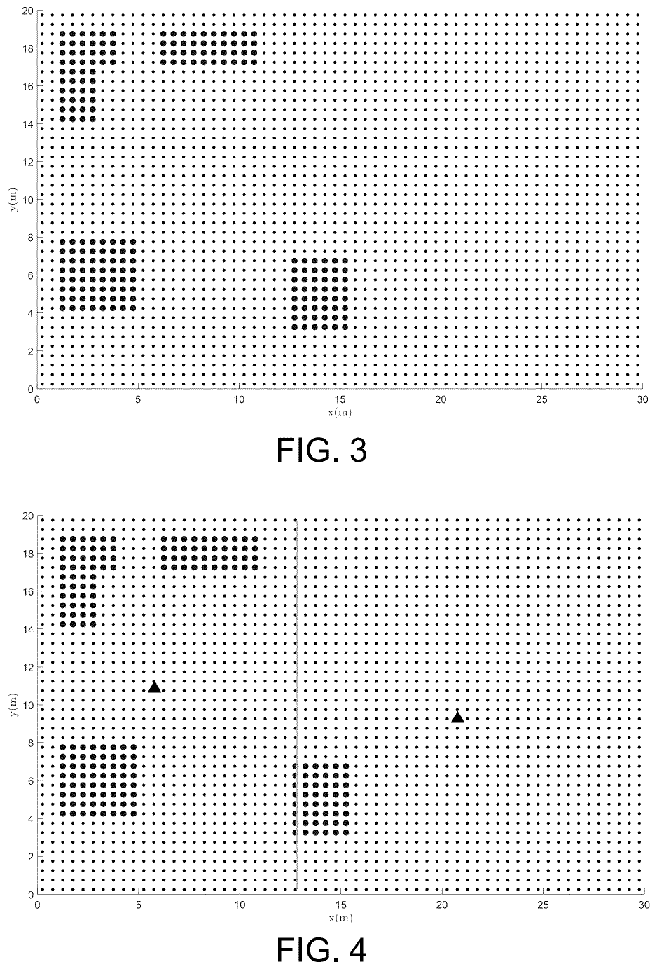

A hyper-rectangle of the optimization region is Q, and Q={(x, y, h_{T})∈R³|0≤x≤a,0≤y≤b}, where a denotes a length of the indoor space, b denotes a width of the indoor space, x denotes a length value of the hyper-rectangle Q, y denotes a width value of the hyper-rectangle Q, h_{T} denotes a height value of an indoor base station, and R³ denotes a three-dimensional real space. By way of example, two base stations are deployed on an indoor ceiling at an indoor Kelvin temperature V of 290 K, with a height h_{T} of 3 m. A transmit power φ_{T} of the base stations is set to 0 dBm, a carrier frequency f is 28 GHz, and a signal bandwidth B is 100 MHz. As shown in FIG. 3, 2,400 receiving points are uniformly arranged indoors with a density of 0.5 m, and a height h_{R} of the receiving points is 1.5 m.
Step 2. determining an indoor millimeter wave network model optimization constraint condition.

By way of example, this step includes calculating a signal power φᵢⱼ received by a receiving point i from a base station j according to the following formula:

$${P}_{ij} = {P}_{T} - {P}_{L , ij} ,$$

where φ_{L,ij} denotes a path loss between the receiving point i and the base station j.

A thermal noise φₙₒᵢₛₑ in the indoor millimeter wave network model is calculated according to the following formula:

$${P}_{noise} = kV B ,$$

where k denotes a Boltzmann constant, and k=1.380658×10⁻²³ J/K

A receiving point is defined as being connected to the base station having a minimum path loss to the receiving point. A set of receiving points connected to base station j is denoted as Sⱼ, a set of receiving points connected to a base station j1 is denoted as Sⱼ₁, and a set of receiving points connected to a base station j2 is denoted as Sⱼ₂. The following conditions need to be satisfied:

$${⋃}_{j = 1}^{n} {S}_{j} = \{ 1 , 2 , … , m \} ;$$

$${S}_{j 1} ⋂ {S}_{j 2} = ∅ , ∀ j 1 \neq j 2.$$

A signal to interference plus noise ratio γᵢ at the receiving point i is calculated according to the following formula:

$${γ}_{i} = \frac{{P}_{i}}{{\sum }_{j = 1 , j \neq q}^{m} {P}_{ij} + {P}_{noise}} ,$$

where Pᵢ denotes a received signal power at the receiving point i; when the receiving point i is connected to a base station q, a signal power P_{iq} received by the receiving point i from the base station q is equal to Pᵢ, and an interference power is

$${\sum }_{j = 1 , j \neq q}^{m} {P}_{ij} .$$

A path loss φ_{L,i} at the receiving point i is calculated according to the following formula:

$${P}_{L , i} = {min}_{j = 1 , 2 , .. n} \{ {P}_{L , ij} \} ,$$

Constructing the constraint condition as:

$$\{ \begin{matrix}{P}_{L , i} < {P}_{L , th} \\ {γ}_{i} > {γ}_{th}\end{matrix} ,$$

where φ_{L,th} denotes a predetermined path loss threshold, and γₜₕ denotes a predetermined signal to interference plus noise ratio threshold. In this embodiment, φ_{L,th} is set to 70 dB, and γₜₕ is set to 7 dB. When P_{L,i} is less than P_{L,th}, the receiving point i is covered by the signal; and when γᵢ is greater than γₜₕ, the signal quality at the receiving point i is good.
Step 3. constructing a cost function of multi-base station location deployment on the basis of the constraint condition. By way of example, this step includes:
constructing a cost function expression F:

$$F = {φ}_{1} {f}_{1} + {φ}_{2} {f}_{2} + {φ}_{3} {f}_{3} ,$$

where f₁ is a first objective function; f₂ is a second objective function; f₃ is a third objective function; and φ₁+φ₂+φ₃=1. In this embodiment, φ₁=0.25, φ₂=0.15, and φ₃=0.6; φ₁ is an optimization priority of the first objective function; φ₂ is an optimization priority of the second objective function; and φ₃ is an optimization priority of the third objective function:

$$\{ \begin{matrix}{f}_{1} = \frac{1}{m} {\sum }_{i = 1}^{m} {ω}_{i} [ {P}_{L , i} + {μ}_{i} max \{ 0 , {P}_{L , i} - {P}_{L , th} \} ] \\ {f}_{2} = \frac{1}{n} {max}_{i = 1 , ... , m} \{ {ω}_{i} [ {P}_{L , i} + {μ}_{i} max \{ 0 , {P}_{L , i} - {P}_{L , th} \} ] \} \\ {f}_{3} = \frac{1}{n} {max}_{i = 1 , ... , m} \{ {μ}_{i} max \{ 0 , {γ}_{th} - {γ}_{i} \} \}\end{matrix} ,$$

where ωᵢ denotes a weight of the receiving point i; and a magnitude of co, characterizes a level of demand for network signal quality at the receiving point i; as shown in FIG. 3, larger dots represent high-weight receiving points with a weight of 1, and smaller dots represent low-weight receiving points with a weight of 0.2. i=1, 2, 3, . . . , m; where m denotes a total number of receiving points in the indoor space; P_{L,i} denotes the path loss at the receiving point i; P_{L,th} denotes a predetermined path loss threshold; γₜₕ denotes a predetermined signal to interference plus noise ratio threshold; μᵢ denotes a penalty factor at the receiving point i; a magnitude of μᵢ characterizes the severity of consequences caused by P_{L,i} and/or γᵢ failing to meet the thresholds; and penalty factors of receiving points are all set to be consistent with their respective weights.

A magnitude of the cost function value represents the network coverage condition and quality level, and a smaller value indicates better network coverage and quality level. Therefore, the base station location optimization process is converted into a process of identifying a minimum value of the cost function under the constraint condition.
Step 4. determining an initial location of each base station in the indoor millimeter wave network model. By way of example, this step includes:
Step 401: determining a weight sum of each hyper-rectangle in a current indoor space, where the weight sum of each hyper-rectangle is a sum of weights of all receiving points within the corresponding hyper-rectangle.
Step 402: Iterating through weight sums of all hyper-rectangles, and determining a hyper-rectangle Q₁ with a maximum sum of weights.
Step 403: Calculating centroid coordinates (x_{Q}_{ⱼ}, y_{Q}_{ⱼ}, h_{T}) of the hyper-rectangle Qⱼ according to the following formula:

$$\{ \begin{matrix}{x}_{{Q}_{j}} = \frac{\sum ( {ω}_{i 1} {x}_{i 1} )}{\sum {ω}_{i 1}} \\ {y}_{{Q}_{j}} = \frac{\sum ( {ω}_{i 1} {y}_{i 1} )}{\sum {ω}_{i 1}}\end{matrix} ,$$

where h_{T} denotes a height value of the indoor base station; ωᵢ₁ denotes a weight of a receiving point i1 within the hyper-rectangle Qⱼ; xᵢ₁ denotes an x-coordinate of the receiving point i1 within the hyper-rectangle Qⱼ; and γᵢ₁ denotes a y-coordinate of the receiving point i1 within the hyper-rectangle Qⱼ.
Step 404: at a centroid of the hyper-rectangle Qⱼ, dividing the hyper-rectangle Qⱼ into two new hyper-rectangles along a width direction of hyper-rectangle Q₁, as shown in FIG. 4, where triangles represent an initial location of the base station, and vertical lines divide the optimization region into two hyper-rectangles.
Step 405: Repeating the steps 401-404 until n centroid coordinates are obtained, and taking the n centroid coordinates as initial locations of n base stations, respectively; where n denotes a total number of base stations in the indoor space.
Step 5: by taking the initial location of each base station as a starting point, determining an optimal location of each base station by means of axial search together with pattern search. By way of example, this step includes:
Step 501: constructing a set of x-coordinates and y-coordinates A^{λ} of optimized base station locations:

$${A}^{λ} = {( {x}_{1}^{λ} , {y}_{1}^{λ} , {x}_{2}^{λ} , {y}_{2}^{λ} , … , {x}_{n}^{λ} , {y}_{n}^{λ} )}^{T} ,$$

where λ is a number of optimizing the base station locations;

$${x}_{n}^{λ}$$

denotes an x-coordinate of a location after λ optimizations of a base station n;

$${y}_{n}^{λ}$$

denotes a y-coordinate of the location after λ optimizations of the base station n; and n denotes a total number of base stations in the indoor space.

Since h_{T} is a constant, during the optimization process, the base station locations must satisfy 0<xⱼ<a, and 0<yⱼ<b. A constraint matrix H is constructed according to the constraint condition:

$$H = {( {\underbrace{a , b , … , a , b}}_{2 n} )}^{T} .$$

Step 502: constructing a set of starting locations B¹ of base stations for axial search:

$${B}^{1} = {( {x}_{1}^{1} , {y}_{1}^{1} , {x}_{2}^{1} , {y}_{2}^{1} , … , {x}_{n}^{1} , {y}_{n}^{1} )}^{T} .$$

Step 503: setting B¹=A¹ before beginning axial search together with pattern search, and performing axial search first. B¹ is moved along 2n-dimensional directions of B¹ respectively by a target step size, and during the movement process, a set of x-coordinates and y-coordinates B²ⁿ⁺¹ of a base station location corresponding to a minimum cost function value is obtained.
Step 504: during pattern search, determining whether F(B²ⁿ⁺¹)<F(A^{l}) is satisfied; where F(B²ⁿ⁺¹) denotes a cost function value when the set of x-coordinates and y-coordinates of the base station locations is B²ⁿ⁺¹; and F(A^{l}) is a cost function value when the set of x-coordinates and y-coordinates of the base station locations is A^{l}.
Step 505: if satisfied, setting A^{l+1}=B²ⁿ⁺¹, and a descent direction vector of the cost function D=A^{l+1}−A^{l}; updating B¹ in a next optimization to A^{l+1}+αD; where l+1≤λ; and α denotes an acceleration factor for accelerating convergence of the axial search and the pattern search;
Step 506: if not satisfied, setting δ^{l+1}=βδ^{l}, A^{l+1}=A^{l}, and updating B¹ in a next optimization to A^{l}; where δ^{l} denotes a step size of an l^{th} location optimization of base station; β denotes a decay factor, and in this embodiment β is 0.5.
Step 507: when performing an l+1 location optimization of base station, determining whether δ¹⁺¹ is greater than a predetermined allowable error ε; and in this embodiment ε is 0.5.
Step 508: if so, repeating the steps 501-507.
Step 509: if not, taking A^{l} as a final set of x-coordinates and y-coordinates of the base station locations, and ending the location optimization of base station.

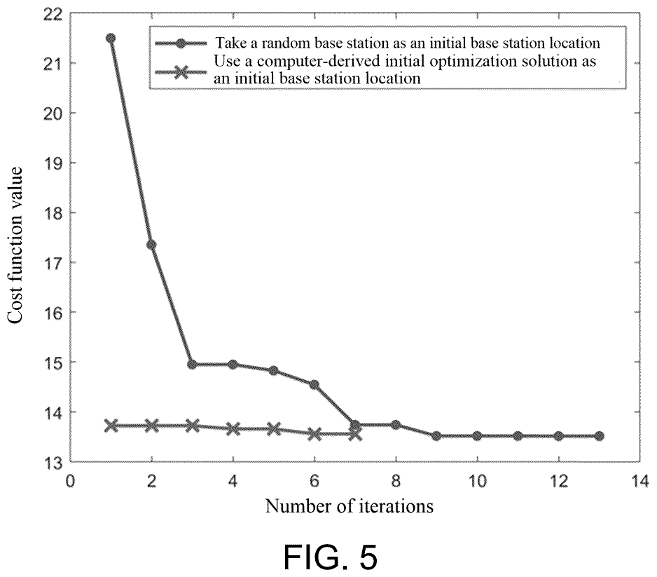

As shown in FIG. 5, the present invention can significantly shorten the convergence time of the optimization algorithm. The present invention adopts the calculated optimized initial solution as an initial base station location, and effectively reduces the number of iterations compared with a conventional optimization method using random base station location as the initial base station location.

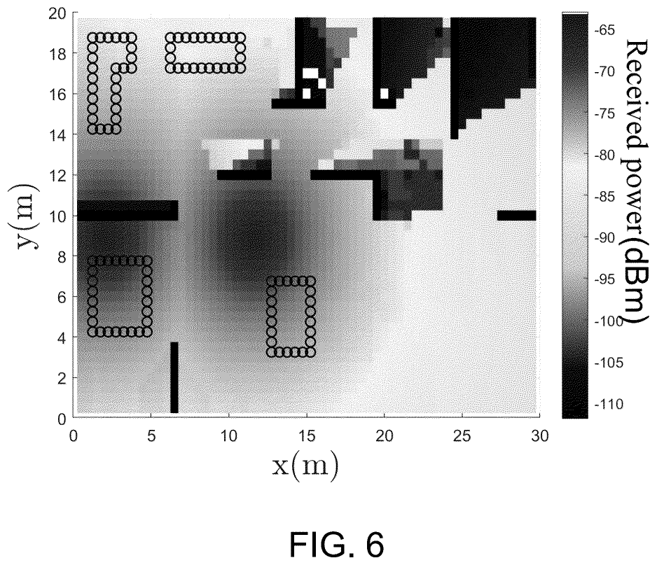

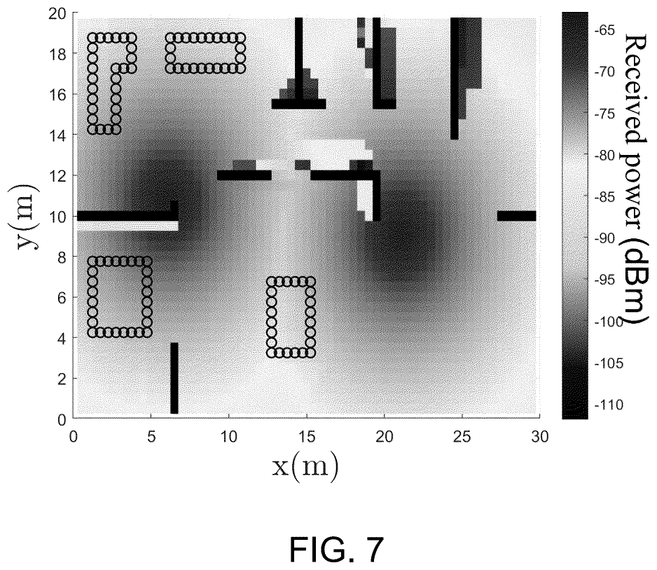

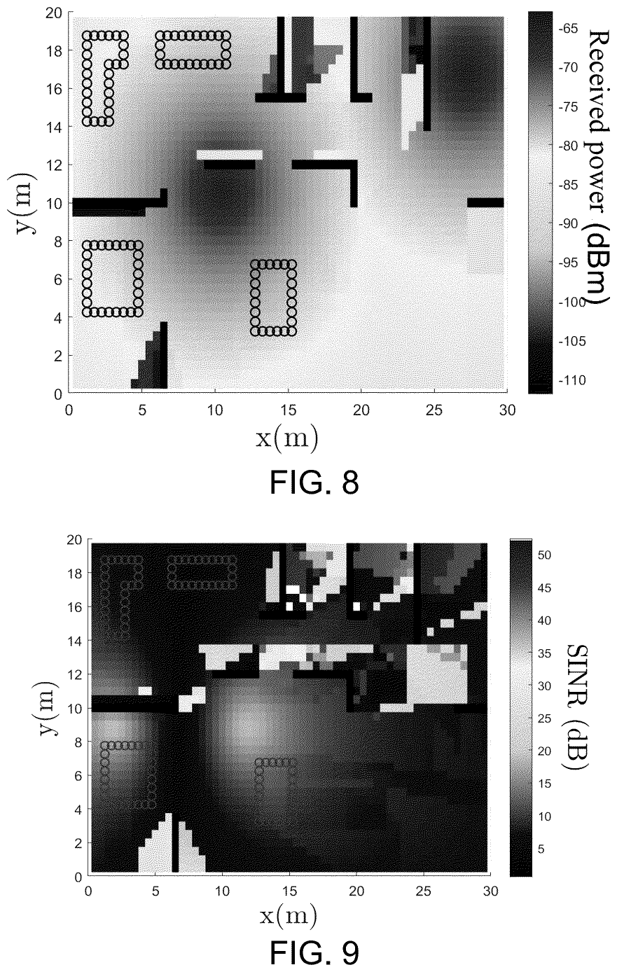

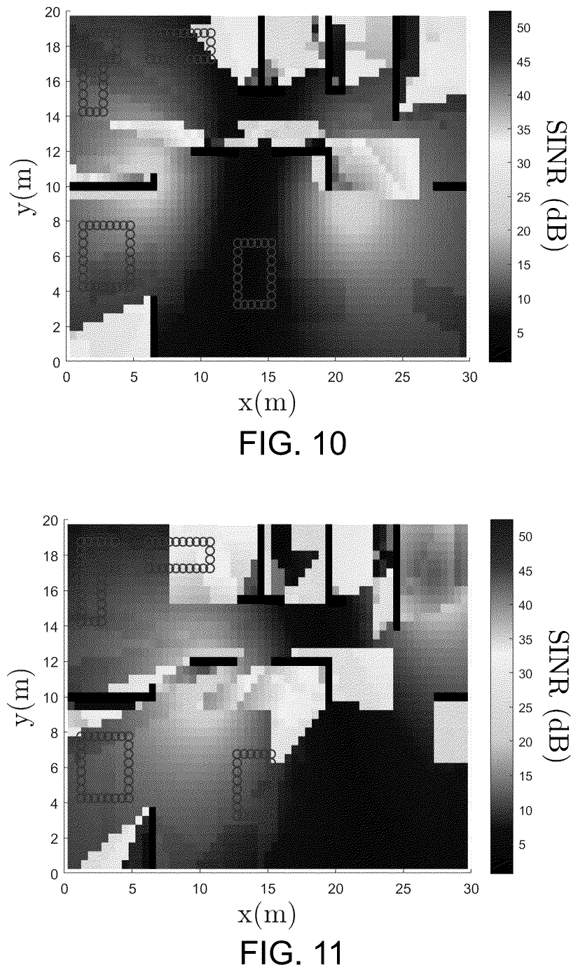

As shown in FIGS. 6, 7 and 8, received power diagrams under three cases of random sites, before optimization and after optimization are illustrated. As shown in FIGS. 9, 10, and 11, signal to interference plus noise ratio (SINR) diagrams under three cases of random sites, before optimization and after optimization are illustrated. It should be noted that before optimization, the calculated optimized initial solution is used as the initial base station location. In the figures, the darkest blocks represent partitions, white regions represent areas with no signal, and high-weight receiving points are surrounded by hollow circles. Analysis shows that the ray-tracing-based axial search together with pattern search in the present invention can effectively optimize the multi-base station deployment problem, and the resulting optimal base station location can effectively reduce path loss and improve SINR in the millimeter-wave network, thereby achieving high-quality signal coverage in the millimeter-wave network.

In another embodiment, the present invention provides a computer device, including a processor and a memory, where when the processor executes computer programs stored in the memory, the steps of the above ray tracing-based method for indoor multi-base station location optimization in a millimeter wave frequency band are implemented.

More specific processes of the above method may refer to the corresponding contents disclosed in the foregoing embodiments and will not be repeated herein.

In another embodiment, the present invention provides a computer-readable storage medium for storing a computer program, where when the computer program is executed by the processor, the steps of the above ray tracing-based method for indoor multi-base station location optimization in a millimeter wave frequency band are implemented.

More specific processes of the above method may refer to the corresponding contents disclosed in the foregoing embodiments and will not be repeated herein.

Each embodiment of the specification is described in a progressive manner, each embodiment focuses on differences from other embodiments, and the same or similar parts between the embodiments may refer to each other. Since the system and storage media disclosed in the embodiments correspond to the method disclosed in the embodiments, the description is simple, and reference can be made to the method description.

Those skilled in the art can clearly understand that the technology in the embodiments of the present invention may be implemented by means of software plus a general-purpose hardware platform. On the basis of the understanding, the technical solution in the embodiments of the present invention, or the parts that contribute to the prior art may be embodied in a form of a software product in essence or a part contributing to the prior art, and the computer software product can be stored in a storage medium (for example, ROM/RAM, magnetic disks, optical discs, and the like), and includes a plurality of instructions for enabling a computer device (which may be a personal computer, server, or network device, etc.) to execute the method described in various embodiments or some parts of the embodiments of the present invention.

The present invention has been described in detail above in conjunction with specific embodiments and exemplary examples; however, these descriptions should not be construed as limiting the present invention. Those skilled in the art will understand that various equivalent substitutions, modifications, or improvements may be made to the technical solutions and embodiments of the present invention without departing from the spirit and scope of the present invention, and all such substitutions, modifications, or improvements shall fall within the scope of the present invention. Accordingly, the scope of protection of the present invention shall be defined by the appended claims.

What is claimed is:

1. A ray tracing-based method for indoor multi-base station location optimization in a millimeter wave frequency band, comprising:
constructing an indoor millimeter wave network model;
determining an indoor millimeter wave network model optimization constraint condition;
constructing a cost function of multi-base station location deployment on the basis of the constraint condition;
determining an initial location of each base station in the indoor millimeter wave network model; and
by taking the initial location of each base station as a starting point, determining an optimal location of each base station by means of axial search together with pattern search.

2. The ray tracing-based method for indoor multi-base station location optimization in a millimeter wave frequency band according to claim 1, wherein the constructing an indoor millimeter wave network model comprises:
constructing a global coordinate system by taking an intersection of length and width of an indoor space as an origin, defining a length direction as an X-axis direction, a width direction as a Y-axis direction, and a direction perpendicular to the X-axis direction and the Y-axis direction as a Z-axis direction, thereby obtaining an indoor hyper-rectangle Q, and Q={(x, y, h_{T})∈R³|0≤x≤a, 0≤y≤b}, wherein a denotes the length of the indoor space, b denotes the width of the indoor space, x denotes a length value of the hyper-rectangle Q, y denotes a width value of the hyper-rectangle Q, h_{T} denotes a height value of an indoor base station, and R³ denotes a three-dimensional real space.

3. The ray tracing-based method for indoor multi-base station location optimization in a millimeter wave frequency band according to claim 1, wherein the determining an indoor millimeter wave network model optimization constraint condition comprises:
calculating a signal power Pᵢⱼ received by a receiving point i from a base station j according to the following formula:
$${P}_{ij} = {P}_{T} - {P}_{L , ij} ;$$
wherein i=1, 2, 3, . . . , m; m denotes a total number of receiving points in the indoor space; j=1, 2, 3, . . . , n; n denotes a total number of base stations in the indoor space; P_{T} denotes a transmit power of the base station; and P_{L,ij} denotes a path loss between the receiving point i and the base station j;
a thermal noise Pₙₒᵢₛₑ in the indoor millimeter wave network model is calculated according to the following formula:
$${P}_{noise} = kVB ;$$
wherein k denotes a Boltzmann constant; V denotes an indoor Kelvin temperature; and B denotes a signal bandwidth;
a signal to interference plus noise ratio γᵢ at the receiving point i is calculated according to the following formula:
$${γ}_{i} = \frac{{P}_{i}}{{{\sum }_{j = 1 , j \neq q}}^{m} {P}_{ij} + {P}_{noise}} ;$$
wherein Pᵢ denotes a received signal power at the receiving point i; when the receiving point i is connected to a base station q, a signal power P_{iq} received by the receiving point i from the base station q is equal to Pᵢ and an interference power is
$${\sum }_{j = 1 , j \neq q}^{m} {P}_{ij} ;$$
a path loss P_{L,i} at the receiving point i is calculated according to the following formula:
$${P}_{L , i} = {min}_{j = 1 , 2 , … n} \{ {P}_{L , ij} \} ;$$
constructing the constraint condition as:
$$\{ \begin{matrix}{P}_{L , i} < {P}_{L , th} \\ {γ}_{i} > {γ}_{t h}\end{matrix} ;$$
wherein P_{L,th} denotes a predetermined path loss threshold, and γₜₕ denotes a predetermined signal to interference plus noise ratio threshold.

4. The ray tracing-based method for indoor multi-base station location optimization in a millimeter wave frequency band according to claim 1, wherein the constructing a cost function of multi-base station location deployment on the basis of the constraint condition comprises:
constructing a cost function expression F:
$$F = {φ}_{1} {f}_{1} + {φ}_{2} {f}_{2} + {φ}_{3} {f}_{3} ;$$
wherein f₁ is a first objective function; f₂ is a second objective function; f₃ is a third objective function; and φ₁+φ₂+φ₃=1, wherein φ₁ is an optimization priority of the first objective function; φ₂ is an optimization priority of the second objective function; and φ₃ is an optimization priority of the third objective function:
$$\{ \begin{matrix}{f}_{1} = \frac{1}{m} {\sum }_{i = 1}^{m} {ω}_{i} [ {P}_{L , i} + {μ}_{i} max \{ 0 , {P}_{L , i} - {P}_{L . , th} \} ] \\ {f}_{2} = \frac{1}{n} {max}_{i = 1 , … , m} \{ {ω}_{i} [ {P}_{L , i} + {μ}_{i} max \{ 0 , {P}_{L , i} - {P}_{L , th} \} ] \} \\ {f}_{3} = \frac{1}{n} {max}_{i = 1 , … , m} \{ {μ}_{i} max \{ 0 , {γ}_{t h} - {γ}_{i} \} \}\end{matrix} ;$$
wherein ωᵢ denotes a weight of a receiving point i; a magnitude of ωᵢ characterizes a level of demand for network signal quality at the receiving point i; i=1, 2, 3, . . . , m, wherein m denotes a total number of receiving points in an indoor space; P_{L,i} denotes a path loss at the receiving point i; P_{L,th} denotes a predetermined path loss threshold; γₜₕ denotes a predetermined signal to interference plus noise ratio threshold; μᵢ denotes a penalty factor at the receiving point i; a magnitude of μᵢ characterizes the severity of consequences caused by P_{L,i} and/or γᵢ failing to meet the thresholds; n denotes a total number of base stations in the indoor space; and γᵢ denotes a signal to interference plus noise ratio at the receiving point i.

5. The ray tracing-based method for indoor multi-base station location optimization in a millimeter wave frequency band according to claim 1, wherein the determining an initial location of each base station in the indoor millimeter wave network model comprises:
step 401: determining a weight sum of each hyper-rectangle in a current indoor space, wherein the weight sum of each hyper-rectangle is a sum of weights of all receiving points within the corresponding hyper-rectangle;
step 402: iterating through weight sums of all hyper-rectangles, and determining a hyper-rectangle Qⱼ with a maximum sum of weights;
step 403: calculating centroid coordinates (x_{Q}_{ⱼ}, y_{Q}_{ⱼ}, h_{T}) of the hyper-rectangle Qⱼ according to the following formula:
$$\{ \begin{matrix}{{x}_{Q}}_{j} = \frac{\sum ( {ω}_{i 1} {x}_{i 1} )}{\sum {ω}_{i 1}} \\ {{y}_{Q}}_{j} = \frac{\sum ( {ω}_{i 1} {y}_{i 1} )}{\sum {ω}_{i 1}}\end{matrix} ;$$
wherein h_{T} denotes a height value of an indoor base station; ωᵢ₁ denotes a weight of a receiving point i1 within the hyper-rectangle Qⱼ; xᵢ₁ denotes an x-coordinate of the receiving point i1 within the hyper-rectangle Qⱼ; and yᵢ₁ denotes a y-coordinate of the receiving point i1 within the hyper-rectangle Qⱼ;
step 404: at a centroid of the hyper-rectangle Qⱼ, dividing the hyper-rectangle Qⱼ into two new hyper-rectangles along a width direction of hyper-rectangle Qⱼ; and
step 405: repeating the steps 401-404 until n centroid coordinates are obtained, and taking the n centroid coordinates as initial locations of n base stations, respectively; wherein n denotes a total number of base stations in the indoor space.

6. The ray tracing-based method for indoor multi-base station location optimization in a millimeter wave frequency band according to claim 1, wherein the by taking the initial location of each base station as a starting point, determining an optimal location of each base station by means of axial search together with pattern search comprises:
step 501: constructing a set of x-coordinates and y-coordinates A^{λ} of optimized base station locations:
$${A}^{λ} = {( {x}_{1}^{λ} , {y}_{1}^{λ} , {x}_{2}^{λ} , {y}_{2}^{λ} , … , {x}_{n}^{λ} , {y}_{n}^{λ} )}^{T} ;$$
wherein λ is a number of optimizing the base station locations;
$${x}_{n}^{λ}$$
denotes an x-coordinate of a location after λ optimizations of a base station n;
$${y}_{n}^{λ}$$
denotes a y-coordinate of the location after λ optimizations of the base station n; and n denotes a total number of base stations in an indoor space;
step 502: constructing a set of starting locations B¹ of base stations for axial search:
$${B}^{1} = {( {x}_{1}^{1} , {y}_{1}^{1} , {x}_{2}^{1} , {y}_{2}^{1} , … , {x}_{n}^{1} , {y}_{n}^{1} )}^{T} ;$$
step 503: moving B¹ along 2n-dimensional directions of B¹ respectively by a target step size, and obtaining a set of x-coordinates and y-coordinates B²ⁿ⁺¹ of a base station location corresponding to a minimum cost function value during the movement process;
step 504: determining whether F(B²ⁿ⁺¹)<F(A^{l}) is satisfied; wherein F(B²ⁿ⁺¹) denotes a cost function value when the set of x-coordinates and y-coordinates of the base station locations is B²ⁿ⁺¹; and F(A^{l}) is a cost function value when the set of x-coordinates and y-coordinates of the base station locations is A^{l};
step 505: if satisfied, setting A^{l+1}=B²ⁿ⁺¹, and a descent direction vector of the cost function D=A^{l+1}−A^{l}; updating B¹ in a next optimization to A^{l+1}+αD; wherein l+1≤λ, and α denotes an acceleration factor for accelerating convergence of the axial search and the pattern search;
step 506: if not satisfied, setting δ^{l+1}=βδ^{l}, A^{l+1}=A^{l}, and updating B¹ in a next optimization to A^{l}; wherein δ^{l} denotes a step size of an l^{th} location optimization of base station; and β denotes a decay factor;
step 507: when performing an l+1 location optimization of base station, determining whether δ^{l+1} is greater than a predetermined allowable error e;
step 508: if so, repeating the steps 501-507; and
step 509: if not, taking A^{l+1} as a final set of x-coordinates and y-coordinates of the base station locations, and ending the location optimization of base station.

7. A computer device, comprising a processor and a memory, wherein when the processor executes computer programs stored in the memory, the steps of the ray tracing-based method for indoor multi-base station location optimization in a millimeter wave frequency band according to claim 1 are implemented.

8. A computer-readable storage medium, configured to store a computer program; and when the computer program is executed by a processor, the steps of the ray tracing-based method for indoor multi-base station location optimization in a millimeter wave frequency band according to claim 1 are implemented.
